(19) United States
(12) Patent Application Publication
(10) Pub. No.: US 2018/0300459 A1
(43) Pub. Date: Oct. 18, 2018

(54) TRACKING FOOD CONSUMPTION

(71) Applicant: INTERNATIONAL BUSINESS MACHINES CORPORATION, ARMONK, NY (US)

(72) Inventors: TARA ASTIGARRAGA, FAIRPORT, NY (US); CHRISTOPHER V. DEROBERTIS, HOPEWELL JUNCTION, NY (US); LOUIE A. DICKENS, TUCSON, AZ (US); JOSE R. MOSQUEDA MEJIA, MICHOACAN (MX); DANIEL J. WINARSKI, TUCSON, AZ (US)

(21) Appl. No.: 15/489,895

(22) Filed: Apr. 18, 2017

(51) Int. Cl. G06F 19/00; G06Q 50/12; G06Q 30/04; G06Q 20/32

(52) U.S. Cl. CPC G06F 19/3475; G06Q 50/12; G06Q 20/3223; G06Q 20/3276; G06Q 30/04

(57) ABSTRACT

Methods, systems and computer program products for tracking food consumption of an individual by scanning of restaurant bill are provided. Aspects include obtaining a list of food items purchased from the restaurant bill and displaying the list of food items to a user. Aspects also include receiving an indication of which of the list of food items the user consumed and obtaining nutritional information for each of the food items that the user consumed. Aspects further include adding the nutritional information for each of the food items that the user consumed to a food intake log for the user.

### BACKGROUND

The present invention relates generally to systems, methods, and computer program products for tracking food consumption and, more specifically, to tracking the food consumption of an individual by scanning a restaurant bill.

Today, more and more people are using mobile applications to track different activities of their lives. One common thing that individuals track is their food consumption. Currently available mobile applications offer several options to track diets and food consumption, these applications often create a detailed analysis of the caloric and nutrition information for the food consumed by the user.

In order to get the best results out of food consumption tracking applications, a user must consistently enter all of the food that they consume each day. However, available food consumption tracking applications rely on the user to manually inputting each food item consumed in order to be stored in the application and analyzed. Manual entry of the food items consumed by individuals is often a time-consuming task and the nature of the data entry task often results in the user not using the application.

### SUMMARY

Embodiments include computer-implemented methods, systems, and computer program products for tracking the food consumption of an individual by scanning of a restaurant bill. Aspects include obtaining a list of food items purchased from the restaurant bill and displaying the list of food items to a user. Aspects also include receiving an indication of which of the list of food items the user consumed and obtaining nutritional information for each of the food items that the user consumed. Aspects further include adding the nutritional information for each of the food items that the user consumed to a food intake log for the user.

Additional features are realized through the techniques of the present invention. Other embodiments and aspects of the invention are described in detail herein and are considered a part of the claimed invention. For a better understanding of the invention with the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features of embodiments of the invention are apparent from the following detailed description taken in conjunction with the accompanying drawings in which:

FIG. 1 depicts a block diagram of system for tracking the food consumption of an individual by scanning of restaurant bill in accordance with an embodiment of the present invention;

FIG. 2 depicts a block diagram of a processing system in accordance with an embodiment of the present invention;

FIG. 3 depicts a restaurant bill in accordance with an embodiment of the present invention;

FIG. 4 depicts a user interface of an application for tracking the food consumption of an individual in accordance with an embodiment of the present invention;

FIG. 5 depicts a flow diagram of a method for tracking the food consumption of an individual by scanning of restaurant bill in accordance with an embodiment of the present invention;

FIG. 6 depicts a flow diagram of a method for obtaining a list of food items purchased from a restaurant bill in accordance with an embodiment of the present invention;

FIG. 7 depicts a cloud computing environment according to an embodiment of the present invention; and

FIG. 8 depicts abstraction model layers according to an embodiment of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Embodiments include systems, methods and computer program products for tracking the food consumption of an individual by scanning of a restaurant bill. In exemplary embodiments, a food consumption tracking application is configured to obtain information regarding food items that a user consumed at a restaurant by scanning the restaurant bill, or receipt, using a mobile device such as a smartphone or a smartwatch. In one embodiment, the restaurant bill can be analyzed using optical character recognition and other techniques to identify the food items listed on the bill. In another embodiment, a barcode can be disposed on the restaurant bill which the food consumption tracking application can use to identify the food items listed on the bill.

Once food consumption tracking application identifies the food items listed on the bill, it presents the items to the user for the user to select which of the listed items the user ate. Optionally, the user can also indicate what percentage of a food item the user ate or any customizations that the user made to the food item. Based on the input from the user, the food consumption tracking application obtains the nutritional information for the consumed food items and adds that nutritional information to a food intake log of the user. By automating the process by which a user enters information regarding food items consumed at a restaurant, users will be more likely to consistently use the food consumption tracking application and will be able to more accurately track their food consumption. In addition, by automating the food entry process users will save time and by being able to quickly enter food items that they ate a restaurant with a minimum manual work.

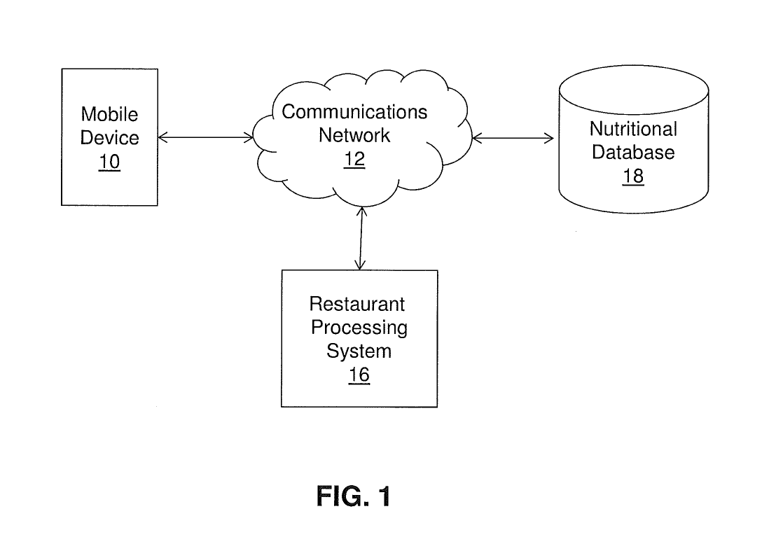

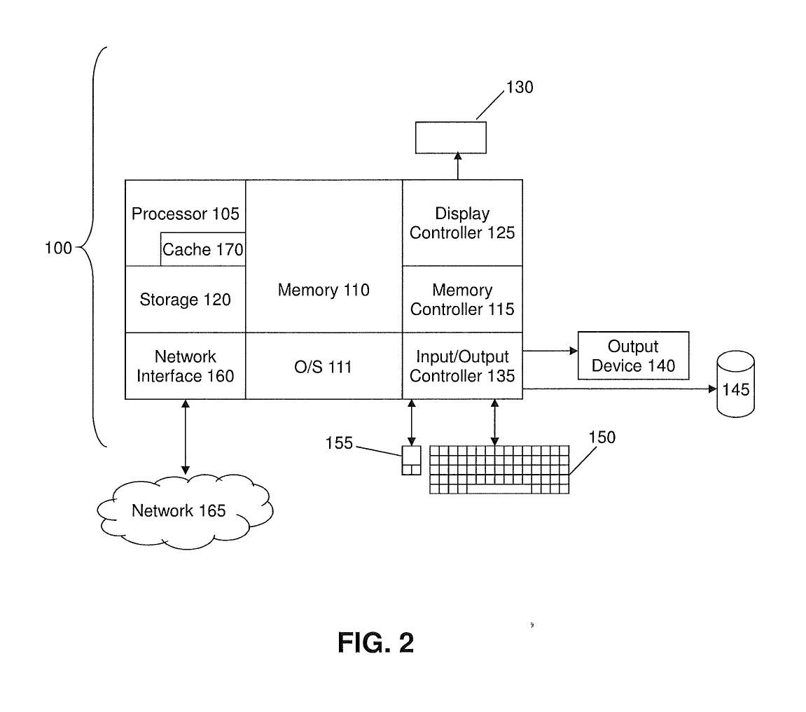

Referring now to FIG. 1, a block diagram of a system for tracking the food consumption of an individual by scanning of restaurant bill in accordance with an embodiment of the present invention is shown. As shown, the system includes a mobile device 10 that is in communication with a nutritional database 18 via a communication network 12. In exemplary embodiments, the mobile device 10 can be a smartphone, tablet, smartwatch, or any other suitable portable electronic device that is capable of scanning a restaurant bill. The nutritional database 18, which may be embodied in a processing system such as the one shown in FIG. 2, stores nutritional information for food items offered for sale by a plurality of restaurants. In exemplary embodiments, the nutritional information can include caloric information, fat content, salt content, and other information regarding each of the food items.

In exemplary embodiments, the nutritional database 18 is in communication with a restaurant processing system 16. The restaurant processing system 16 is configured to provide the nutritional information for each of the food items to the nutritional database 18. In exemplary embodiments, restaurant processing system 16 is configured to provide the nutritional database 18 with an identification of the food items listed on a receipt and with an identification number for the receipt. In addition, the restaurant processing system 16 includes this identification number on the receipt in the form of a barcode, which may be a traditional bar code or a two-dimensional bar code. In exemplary embodiments, the restaurant processing system 16 can be the point of sale system of a restaurant.

FIG. 2 illustrates a block diagram of a processing system 100 for use in implementing a system or method according to some embodiments. The systems and methods described herein may be implemented in hardware, software (e.g., firmware), or a combination thereof. In some embodiments, the methods described may be implemented, at least in part, in hardware and may be part of the microprocessor of a special or general-purpose computer, such as a personal computer, workstation, minicomputer, or mainframe computer.

In some embodiments, as shown in FIG. 2, the processing system 100 includes a processor 105, a memory 110 coupled to a memory controller 115, and one or more input devices 145 and/or output devices 140, such as peripheral or control devices that are communicatively coupled via a local I/O controller 135. These devices 140 and 145 may include, for example, battery sensors, position sensors, cameras, microphones and the like. Input devices such as a conventional keyboard 150 and mouse 155 may be coupled to the I/O controller. The I/O controller 135 may be, for example, one or more buses or other wired or wireless connections, as are known in the art. The I/O controller 135 may have additional elements, which are omitted for simplicity, such as controllers, buffers (caches), drivers, repeaters, and receivers, to enable communications.

The I/O devices 140, 145 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 105 is a hardware device for executing hardware instructions or software, particularly those stored in memory 110. The processor 105 may be a custom made or commercially available processor, a central processing unit (CPU), an auxiliary processor, a semiconductor based microprocessor (in the form of a microchip or chip set), a macroprocessor, or other device for executing instructions. The processor 105 includes a cache 170 that can be organized as a hierarchy of more cache levels (L1, L2, etc.).

The memory 110 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read-only memory (PROM), tape, compact disc read only memory (CD-ROM), disk, diskette, cartridge, cassette or the like, etc.). Moreover, the memory 110 may incorporate electronic, magnetic, optical, or other types of storage media. Note that the memory 110 may have a distributed architecture, where various components are situated remote from one another but may be accessed by the processor 105.

The instructions in memory 110 may include one or more separate programs, each of which comprises an ordered listing of executable instructions for implementing logical functions. In the example of FIG. 2, the instructions in the memory 110 include a suitable operating system (OS) 111. The operating system 111 essentially may control the execution of other computer programs and provides scheduling, input-output control, file and data management, memory management, and communication control and related services.

Additional data, including, for example, instructions for the processor 105 or other retrievable information, may be stored in storage 120, which may be a storage device such as a hard disk drive or solid state drive. The stored instructions in memory 110 or in storage 120 may include those enabling the processor to execute one or more aspects of the systems and methods of this disclosure.

The processing system 100 may further include a display controller 125 coupled to a user interface or display 130. In some embodiments, the display 130 may be an LCD screen. In some embodiments, the processing system 100 may further include a network interface 160 for coupling to a communications network 165. The network 165 may be an IP-based network for communication between the processing system 100 and an external server, client and the like via a broadband connection. In some embodiments, the network 165 may be a managed IP network administered by a service provider. The communications network 165 may be implemented in a wireless fashion, e.g., using wireless protocols and technologies, such as WiFi, WiMax, satellite, etc. The communications network 165 may also be a packet-switched network such as a local area network, wide area network, metropolitan area network, the Internet, or other similar type of network environment. The communications network 165 may be a fixed wireless network, a wireless local area network (LAN), a wireless wide area network (WAN) a personal area network (PAN), a virtual private network (VPN), intranet or other suitable network system and may include equipment for receiving and transmitting signals.

Systems and methods according to this disclosure may be embodied, in whole or in part, in computer program products or in the processing system 100, such as that illustrated in FIG. 2.

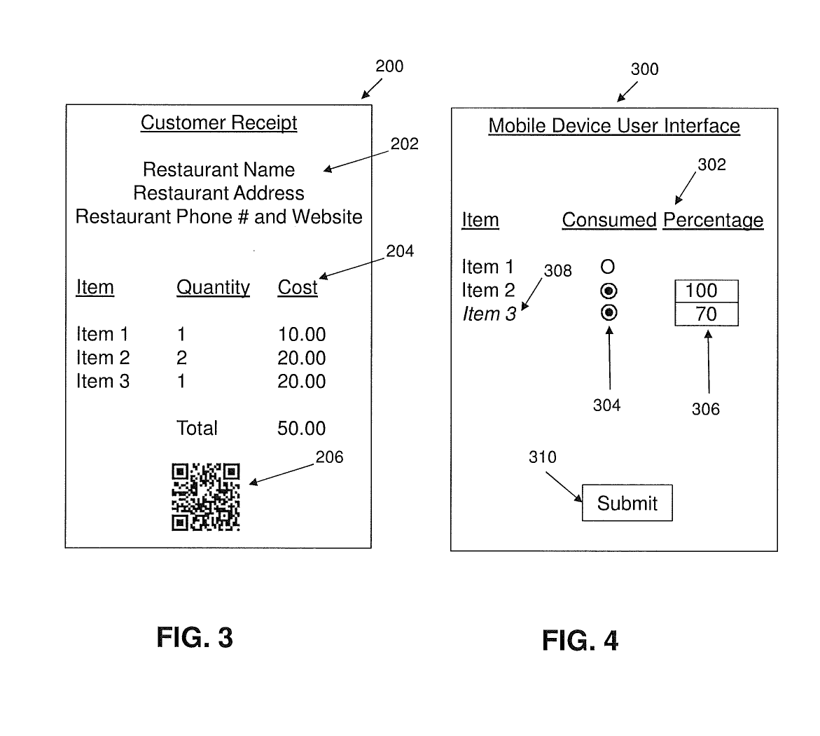

Referring now to FIG. 3, a restaurant bill 200 in accordance with an embodiment is shown. The restaurant bill 200 includes restaurant identification information 202, such as the name and address of the restaurant. The restaurant bill 200 also includes a list of food items purchased 204. The list of food items purchased 204 can include a description of the item, a quantity of the items ordered, and a cost of the items purchased. In exemplary embodiments, the restaurant bill 200 can also include a barcode 206. In one embodiment, the barcode 206 can include an identification number for the restaurant bill 200. In another embodiment, the barcode 206 can include an identification of the restaurant and identification of each of the food items purchased 204.

Referring now to FIG. 4, a user interface 300 of an application for tracking the food consumption of an individual in accordance with an embodiment of the present invention is shown. The user interface 300 is configured to display the list of food items purchased that is obtained from a restaurant bill, such as the one shown in FIG. 3. The user interface 300 displays a list of food items purchased 302 and allows a user to indicate which of the food items they consumed using a selection button 304. In exemplary embodiments, the user interface 300 also allows a user to provide an indication of the amount of each of the food item that they consumed using an input box 306. In one embodiment, the user can enter a percentage of a serving of the item using that they consumed using the input box 306.

In exemplary embodiments, a user can click on any of the food items 308 listed in the list of food items purchased 302 to customize the food item based on their order. For example, if a food item listed is a cheeseburger that comes with mayonnaise but the user ordered it without mayonnaise, the user can click on the food item 308 and indicate that the user ordered the item without mayonnaise. In some embodiments, this item customization information may also be displayed on the restaurant bill and can be captured by the food consumption tracking application when obtaining the list of food items purchased from the restaurant bill.

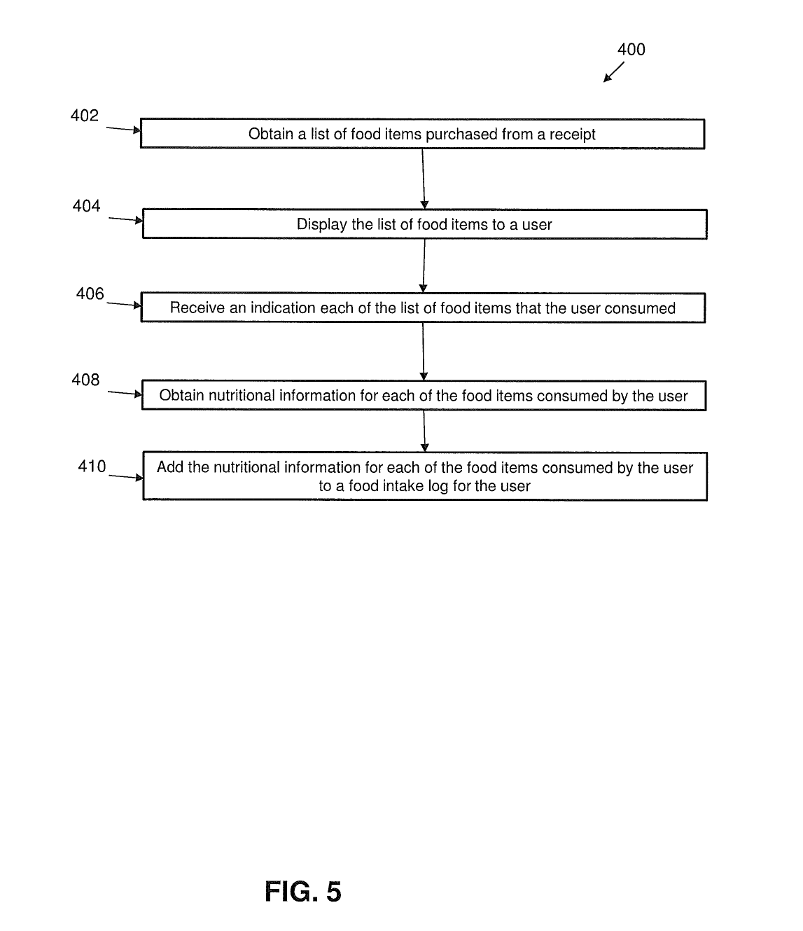

Referring now to FIG. 5, a flow diagram of a method 400 for tracking the food consumption of an individual by scanning of restaurant bill in accordance with an embodiment of the present invention is depicted. As shown at block 402, the method 400 includes obtaining a list of food items purchased from the restaurant bill. In exemplary embodiments, the list of food items purchased from the restaurant bill can be obtained by scanning a barcode, such as a two-dimensional barcode, on a restaurant bill or by performing visual analytics, such as optical character recognition on the restaurant bill. In exemplary embodiments, obtaining the list of food items can include searching a nutritional database based on an identity of the restaurant a candidate list of food items that are captured based on the visual analytics of the restaurant bill.

Next, as shown at block 404, the method 400 includes displaying the list of food items to a user. For example, the list of food items can be displayed to the user using a user interface similar to the one shown in FIG. 4. The method 400 also includes receiving an indication of which of the list of food items the user consumed, as shown at block 406. In exemplary embodiments, the indication of which of the list of food items the user consumed includes an amount, such as a percentage of a servicing, of each of the food items that the user consumed.

The method 400 also includes obtaining nutritional information for each of the food items that the user consumed, as shown at block 408. In exemplary embodiments, the nutritional information for each of the food items that the user consumed is obtained by querying a nutritional information database. This database query can be based on the information contained within the barcode or based on information obtained by performing visual analytics on the restaurant bill. Next, as shown at block 410, the method 400 includes adding the nutritional information for each of the food items that the user consumed to a food intake log for the user. In exemplary embodiments, the nutritional information added to the food intake log for each of the food items that the user consumed by the user can be determined based on the amount of each of the food items that the user consumed if provided by the user.

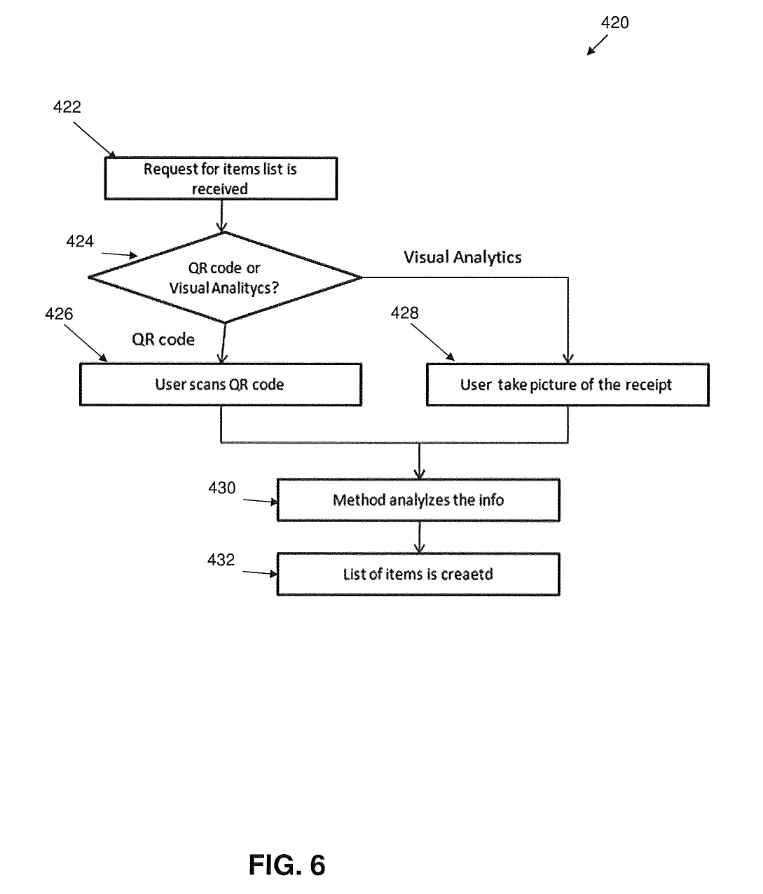

Referring now to FIG. 6, a flow diagram of a method 420 for obtaining a list of food items purchased from a restaurant bill in accordance with an embodiment of the present invention is depicted. As shown at block 422, the method 420 includes receiving a request for a list of food items on a restaurant bill. Next, as shown at decision block 424, it is determined whether a barcode or visual analytics will be used to capture the requested information. If a barcode, or QR code, will be used, the method proceeds to block 426 and the user scans the barcode. Otherwise, the method proceeds to block 428 and the user takes a picture of the restaurant bill. As shown at block 430, the information obtained from the QR code or the visual analytics of the restaurant bill is analyzed, which may include querying a database based on the obtained information. Next, as shown at block 432, the method includes creating the list of items.

In one embodiment, the methods and systems disclosed herein can also be utilized to track food consumed by people in restaurants or places. For example, the food consumption application can track what items a user ate and when and where the user at them. In the case of a public or personal health problem, this consumption data can be used for reporting/tracking potential sources of food poisoning to the local health department. In addition, this tracking data could be used to warn the local health departments where potentially contaminated food was served.

It should be appreciated that while embodiments herein refer to a processing system or mobile device for tracking the food consumption of an individual, this is for exemplary purposes and the claims should not be so limited. In other embodiments, the tracking the food consumption of an individual may be performed by a plurality of computing devices, a distributed computing environment or a cloud computing environment. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts).

Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

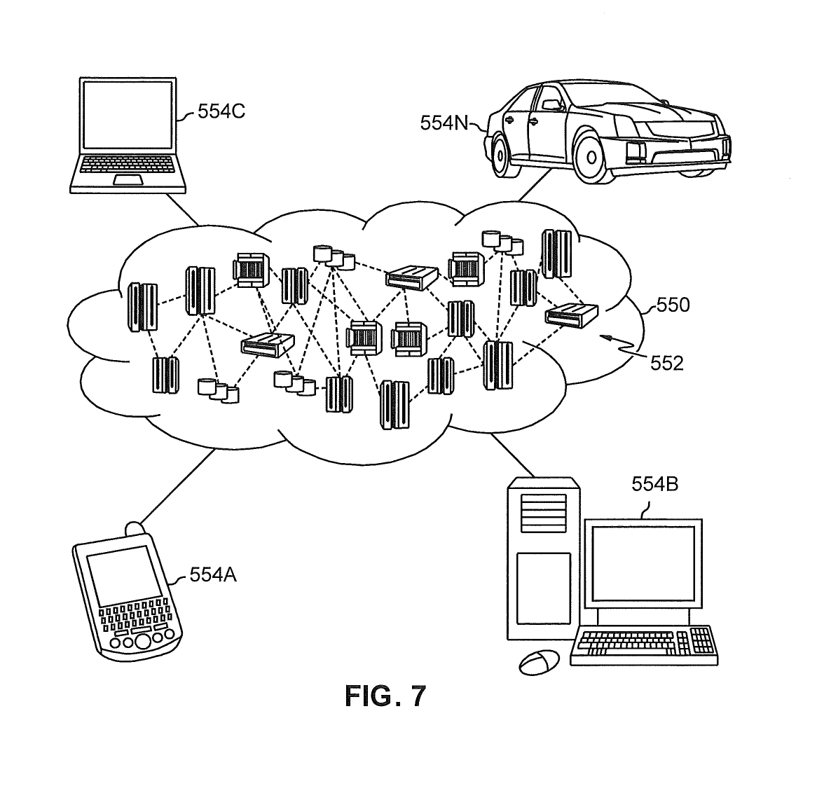

Referring now to FIG. 7, illustrative cloud computing environment 550 is depicted. As shown, cloud computing environment 550 comprises one or more cloud computing nodes 552 with which local computing devices used by cloud consumers, such as, for example, personal digital assistant (PDA) or cellular telephone 554A, desktop computer 554B, laptop computer 554C, and/or automobile computer system 554N may communicate. Nodes 552 may communicate with one another. They may be grouped (not shown) physically or virtually, in one or more networks, such as Private, Community, Public, or Hybrid clouds as described hereinabove, or a combination thereof. This allows cloud computing environment 550 to offer infrastructure, platforms and/or software as services for which a cloud consumer does not need to maintain resources on a local computing device. It is understood that the types of computing devices 554A-N shown in FIG. 7 are intended to be illustrative only and that computing nodes 552 and cloud computing environment 550 can communicate with any type of computerized device over any type of network and/or network addressable connection (e.g., using a web browser).

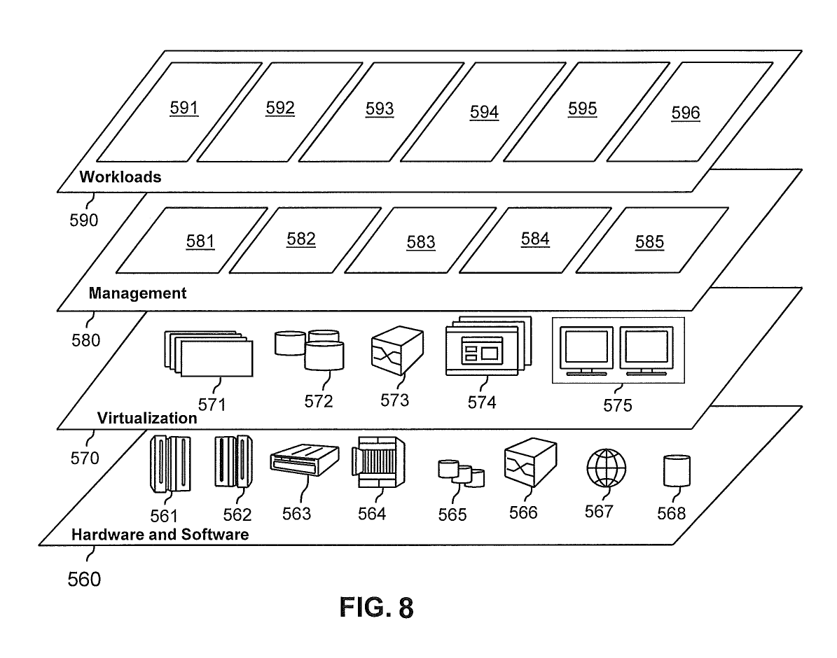

Referring now to FIG. 8, a set of functional abstraction layers provided by cloud computing environment 550 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 560 includes hardware and software components. Examples of hardware components include: mainframes 561; RISC (Reduced Instruction Set Computer) architecture based servers 562; servers 563; blade servers 564; storage devices 565; and networks and networking components 566. In some embodiments, software components include network application server software 567 and database software 568.

Virtualization layer 570 provides an abstraction layer from which the following examples of virtual entities may be provided: virtual servers 571; virtual storage 572; virtual networks 573, including virtual private networks; virtual applications and operating systems 574; and virtual clients 575.

In one example, management layer 580 may provide the functions described below. Resource provisioning 581 provides dynamic procurement of computing resources and other resources that are utilized to perform tasks within the cloud computing environment. Metering and Pricing 582 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 583 provides access to the cloud computing environment for consumers and system administrators. Service level management 584 provides cloud computing resource allocation and management such that required service levels are met. Service Level Agreement (SLA) planning and fulfillment 585 provides pre-arrangement for, and procurement of, cloud computing resources for which a future requirement is anticipated in accordance with an SLA.

Workloads layer 590 provides examples of functionality for which the cloud computing environment may be utilized. Examples of workloads and functions which may be provided from this layer include: mapping and navigation 591; software development and lifecycle management 592; virtual classroom education delivery 593; data analytics processing 594; transaction processing 595; and a food consumption tracking 596. The food consumption tracking application 596 may perform one or more methods for tracking food items consumed by a user by scanning a restaurant bill, such as but not limited to the methods described in reference to FIG. 5 for example.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for tracking food consumption of an individual by scanning of a restaurant bill, the method comprising:
obtaining a list of food items purchased from the restaurant bill;
displaying the list of food items to a user;
receiving an indication of which of the list of food items the user consumed;
obtaining, by a processor, nutritional information for each of the food items that the user consumed; and
adding, by the processor, the nutritional information for each of the food items that the user consumed to a food intake log for the user.

2. The computer-implemented method of claim 1, wherein the list of food items is obtained by scanning the restaurant bill and using visual analytics to identify an identity of the restaurant and to identify a candidate list of food items.

3. The computer-implemented method of claim 2, wherein obtaining the list of food items further comprises searching a nutritional database based on the identity of the restaurant the candidate list of food items.

4. The computer-implemented method of claim 1, wherein the list of food items is obtained by scanning a barcode on the restaurant bill and querying a nutritional database based on the barcode.

5. The computer-implemented method of claim 4, wherein the barcode is a two-dimensional barcode.

6. The computer-implemented method of claim 1, wherein the indication of which of the list of food items the user consumed includes an amount of each of the food items that the user consumed.

7. The computer-implemented method of claim 6, wherein the nutritional information added to the food intake log for each of the food items that the user consumed by the user is determined based on the amount of each of the food items that the user consumed.

8. A system for tracking food consumption of an individual by scanning of restaurant bill, the system comprising:
a memory;
a processor communicatively coupled to the memory, wherein the processor is configured to:
obtain a list of food items purchased from the restaurant bill;
display the list of food items to a user;
receive an indication of which of the list of food items the user consumed;
obtain, by a processor, nutritional information for each of the food items that the user consumed; and
add, by the processor, the nutritional information for each of the food items that the user consumed to a food intake log for the user.

9. The system of claim 8, wherein the list of food items is obtained by scanning the restaurant bill and using visual analytics to identify an identity of the restaurant and to identify a candidate list of food items.

10. The system of claim 9, wherein obtaining the list of food items further comprises searching a nutritional database based on the identity of the restaurant the candidate list of food items.

11. The system of claim 8, wherein the list of food items is obtained by scanning a barcode on the restaurant bill and querying a nutritional database based on the barcode.

12. The system of claim 11, wherein the barcode is a two-dimensional barcode.

13. The system of claim 8, wherein the indication of which of the list of food items the user consumed includes an amount of each of the food items that the user consumed.

14. The system of claim 13, wherein the nutritional information added to the food intake log for each of the food items that the user consumed by the user is determined based on the amount of each of the food items that the user consumed.

15. A computer program product comprising a computer readable storage medium having program instructions embodied therewith, the program instructions executable by a processor to cause the processor to perform a method comprising:
obtaining a list of food items purchased from the restaurant bill;
displaying the list of food items to a user;
receiving an indication of which of the list of food items the user consumed;
obtaining nutritional information for each of the food items that the user consumed; and
adding the nutritional information for each of the food items that the user consumed to a food intake log for the user.

16. The computer program product of claim 15, wherein the list of food items is obtained by scanning the restaurant bill and using visual analytics to identify an identity of the restaurant and to identify a candidate list of food items.

17. The computer program product of claim 16, wherein obtaining the list of food items further comprises searching a nutritional database based on the identity of the restaurant the candidate list of food items.

18. The computer program product of claim 15, wherein the list of food items is obtained by scanning a barcode on the restaurant bill and querying a nutritional database based on the barcode.

19. The computer program product of claim 15, wherein the indication of which of the list of food items the user consumed includes an amount of each of the food items that the user consumed.

20. The computer program product of claim 19, wherein the nutritional information added to the food intake log for each of the food items that the user consumed by the user is determined based on the amount of each of the food items that the user consumed.
